(19) United States
(12) Patent Application Publication
(10) Pub. No.: US 2018/0268425 A1
(43) Pub. Date: Sep. 20, 2018

(54) INFORMATION PROCESSING APPARATUS, INFORMATION PROCESSING METHOD, AND COMPUTER-READABLE STORAGE MEDIUM

(71) Applicant: NEC CORPORATION, Tokyo (JP)

(72) Inventors: Yusuke MURAOKA, Tokyo (JP); Ryohei FUJIMAKI, Tokyo (JP)

(21) Appl. No.: 15/756,052

(22) PCT Filed: Aug. 9, 2016
(86) PCT No.: PCT/JP2016/073474

§ 371 Date: Feb. 27, 2018

Related U.S. Application Data
(60) Provisional application No. 62/212,084, filed on Aug. 31, 2015.

(51) Int. Cl. G06Q 30/02; G06F 17/18

(52) U.S. Cl. CPC G06Q 30/0201; G06Q 30/0202; G06F 17/18

(57) ABSTRACT

An information processing apparatus 100 includes: a reception unit 10 that receives analysis subjects and variables relating to the analysis subjects; and a graph generation unit 20 that specifies degrees of influence that the variables have on the analysis subjects with the degrees of influence divided into positive and negative, and generates a graph indicating the specified degrees of positive influence and the specified degrees of negative influence as distances between the variables and the analysis subjects.

### CROSS-REFERENCE TO RELATED PATENT APPLICATIONS

This application is a National Stage Entry of International Application No. PCT/JP2016/073474, filed Aug. 9, 2016, which claims priority from U.S. Provisional Application No. 62/212,084, filed Aug. 31, 2015. The entire contents of the above-referenced applications are expressly incorporated herein by reference.

### TECHNICAL FIELD

The present invention relates to an information processing apparatus and an information processing method for assisting analysis of the influence of multiple factors on multiple subjects, and a computer-readable storage medium storing a program for realizing the information processing apparatus and the information processing method.

### BACKGROUND ART

In recent years, various analyses have been performed in order to achieve improvements in sales in fields such as retail. For example, Non-Patent Document 1 discloses a technique for assisting an improvement in a store's sales by using multiple regression analysis to analyze factors that have an influence on sales of products in a convenience store.

Specifically, in the technique disclosed in Non-Patent Document 1, first, four elements, namely, customer service, product selection, area, and location, are envisioned as candidates for factors that have an influence on net sales. Next, in the technique disclosed in Non-Patent Document 1, for each store, the net sales are used as a target variable, customer service, product selection, area, and location are used as explanatory variables, and the relationship between the target variable and the explanatory variables are analyzed using multiple regression analysis.

Also, in the technique disclosed in Non-Patent Document 1, the factors that have an influence on the sales of a convenience store are analyzed using a multiple regression equation obtained as a result of multiple regression analysis. Accordingly, for example, a manager such as a shop manager of a convenience store can achieve an improvement in the store's sales by using the analysis result as a basis for determining the priority levels of the factors for improvement, and executing measures for improving the factors with high priority levels.

Also, in actuality, the manager of the convenience store uses the analysis result as one piece of reference information to consider which measure to carry out while giving consideration to the analysis result, as well as to various restrictions in operating a convenience store, the cost of realizing the measure, and the like.

In addition, Non-Patent Document 2 discloses a technique for predicting prediction subjects that are classified for each segment, using a prediction formula that is different for each segment. Specifically, Non-Patent Document 2 discloses a solution for predicting demand for a product in retail at a convenience store, grocery store, or the like. In the solution disclosed in Non-Patent Document 2, prediction equations that are different for each store or each product (i.e., each segment) are created, and demand for products is predicted using the prediction equations.

Specifically, according to the technique disclosed in Non-Patent Document 2, for example, for each product, a prediction equation is created in which the temperature of the store, the humidity of the store, the brightness of the lighting in the store, and the like are used as parameters. For this reason, for each product, the manager of the store can predict the demand using the corresponding prediction equations, and therefore the manager can effectively procure the products.

### CITATION LIST

### Non-Patent Documents

Non-Patent Document 1: Masashige SUEYOSHI, “Do Customer Service, Location, and Selection Influence Sales the Most? Determining Priority Levels for Improvement with Multiple Regression Analysis”, [Online], Sep. 21, 2012, Shoeisha Co., Ltd., [searched for on Aug. 1, 2015], Internet <http://markezine.jp/article/detail/16294>
Non-Patent Document 2: “Selling Retail Solutions for Realizing Correct Order Placement Using NEC and Big Data Analysis Technology”, [online], Apr. 10, 2015, NEC Corporation, [searched for on Aug. 1, 2015], Internet <http://jpn.nec.com/press/201504/20150410_01.html>

### DISCLOSURE OF THE INVENTION

### Problems to be Solved by the Invention

Accordingly, a manager of a certain store can use the technique disclosed in the above-described Non-Patent Document 2 to create prediction equations for product A, product B, and product C of the store, predict demand for the products, and can achieve an improvement in sales of the products using the technique disclosed in the above-described Non-Patent Document 1.

However, drafting an appropriate measure using the techniques disclosed in the above-described Non-Patent Documents 1 and 2 is a difficult task for the manager of the store in actuality. The reason for this is as follows.

First, for example, it is assumed that the manager is making a plan to improve sales of the three products, namely product A, product B, and product C. Next, the manager creates prediction equations for product A, product B, and product C using the techniques disclosed in the above-described Patent Document 2 and specifies the factors that contribute to an improvement in sales using the prediction equations. Next, the manager carries out the multiple regression analysis disclosed in the above-described Non-Patent Document 1 with the specified factors used as elements, and upon performing factor analysis based on the result, results (a) to (c) described below are obtained.

(a) The highness of the temperature of the store has a strong positive influence on the sales of product A, and the brightness of the lights in the store has a strong positive influence on the sales of product A.

(b) The highness of the temperature of the store has a strong positive influence on the sales of product B.

(c) The highness of the humidity of the store has a positive influence on the sales of product C and the brightness of the lights in the store has a strong negative influence on the sales of product C.

When the above-described results (a) to (c) are considered, for example, a result is obtained in which if the manager carries out a measure of performing adjustment such that the lights of the store become brighter, the sales of product A will be favorably influenced, but the sales of product C will be adversely influenced. Also, if the manager executes a measure of adjusting the humidity of the store to be higher, the sales of product C will be favorably influenced, but the sales of products A and B will hardly be influenced at all.

Thus, drafting the correct measure in a situation in which multiple factors have different influences on the sales of multiple products is a difficult task for the manager. For this reason, in this example, it is thought that it is important to enable the manager to understand the relationships between the multiple factors and the sales of the multiple products.

An example of an object of the present invention lies in providing an information processing apparatus, an information processing method, and a computer-readable storage medium according to which the above-described problems are eliminated and an analyzer can easily understand the influence that multiple factors have on multiple subjects.

### Means for Solving the Problems

In order to achieve the above-described object, a first information processing apparatus according to an aspect of the present invention includes:

a reception unit configured to receive target variables and explanatory variables relating to the target variables; and

a graph generation unit configured to specify degrees of influence that the explanatory variables have on the target variables with the degrees of influence divided into positive and negative and generate a graph showing the specified degrees of positive influence and the specified degrees of negative influence as distances between the explanatory variables and the target variables.

In order to achieve the above-described object, a second information processing apparatus according to an aspect of the present invention includes:

a reception unit configured to receive target variables, explanatory variables relating to the target variables, degrees of positive influence that the explanatory variables have on the target variables, and degrees of negative influence that the explanatory variables have on the target variables; and

a graph generation unit configured to generate a graph indicating the degrees of positive influence and the degrees of negative influence as distances between the explanatory variables and the target variables.

Also, in order to achieve the above-described object, a first information processing method according to an aspect of the present invention includes:

(a) a step of receiving target variables and explanatory variables relating to the target variables; and
(b) a step of specifying degrees of influence that the explanatory variables have on the target variables with the degrees of influence divided into positive and negative, and generating a graph showing the specified degrees of positive influence and the specified degrees of negative influence as distances between the explanatory variables and the target variables.

Also, in order to achieve the above-described object, a second information processing method according to an aspect of the present invention includes:

(a) a step of receiving target variables, explanatory variables relating to the target variables, degrees of positive influence that the explanatory variables have on the target variables, and degrees of negative influence that the explanatory variables have on the target variables; and
(b) a step of generating a graph indicating the degrees of positive influence and the degrees of negative influence as distances between the explanatory variables and the target variables.

Furthermore, in order to achieve the above-described object, a first computer-readable storage medium according to an aspect of the present invention stores a program that includes commands for causing a computer to execute:

(a) a step of receiving target variables and explanatory variables relating to the target variables; and

(b) a step of specifying degrees of influence that the explanatory variables have on the target variables with the degrees of influence divided into positive and negative, and generating a graph showing the specified degrees of positive influence and the degrees of negative influence as distances between the explanatory variables and the target variables.

Furthermore, in order to achieve the above-described object, a second computer-readable storage medium according to an aspect of the present invention stores a program including commands for causing a computer to execute:

(a) a step of receiving target variables, explanatory variables relating to the target variables, degrees of positive influence that the explanatory variables have on the target variables, and degrees of negative influence that the explanatory variables have on the target variables; and
(b) a step of generating a graph indicating the degrees of positive influence and the degrees of negative influence as distances between the explanatory variables and the target variables.

### Effects of the Invention

As described above, with the present invention, it is possible for an analyzer to easily understand the influence that multiple factors have on multiple subjects.

### BRIEF DESCRIPTION OF THE DRAWINGS

FIG. 1 is a block diagram showing a schematic configuration of an information processing apparatus according to an embodiment of the present invention.

FIG. 2 is a block diagram showing a specific configuration of an information processing apparatus according to an embodiment of the present invention.

FIG. 3 is a diagram showing an example of results of processing for specifying degrees of influence according to an embodiment of the present invention.

FIG. 4 is a diagram showing an example of a graph generated in an embodiment of the present invention.

FIG. 5 is a flow diagram showing operations of an information processing apparatus according to an embodiment of the present invention.

FIG. 6 is a diagram showing results of processing for specifying degrees of influence according to a specific example of an embodiment of the present invention.

FIG. 7 is a diagram showing an example of a graph generated in a specific example of an embodiment of the present invention.

FIG. 8 is a diagram showing another example of a graph generated in a specific example of an embodiment of the present invention.

FIG. 9 is a block diagram showing an example of a computer that realizes an information processing apparatus according to an embodiment of the present invention.

### DESCRIPTION OF EMBODIMENT

### Embodiment

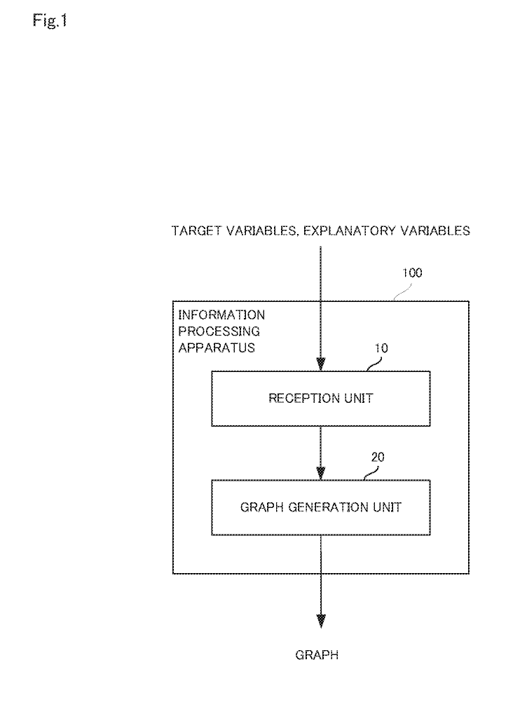

Hereinafter, an information processing apparatus, an information processing method, and a program according to an embodiment of the present invention will be described with reference to FIGS. 1 to 9.

### Configuration of Apparatus

First, a configuration of the information processing apparatus of the present embodiment will be described. FIG. 1 is a block diagram showing a schematic configuration of an information processing apparatus according to an embodiment of the present invention.

As shown in FIG. 1, an information processing apparatus 100 according to the present embodiment includes a reception unit 10 and a graph generation unit 20. The reception unit 10 receives target variables and explanatory variables relating to the target variables.

The graph generation unit 20 first specifies the degrees of influence that the explanatory variables have on the target variables, with the degrees of influence divided into positive and negative. Next, the graph generation unit 20 generates a graph showing the specified positive degrees of influence and negative degrees of influence as distances between the explanatory variables and the target variables.

In this way, according to the information processing apparatus 100, the influences that the factors expressed by the explanatory variables have on the target variables are visually expressed on the graph. Also, at this time, it is expressed whether the influences received by the target variables are positive or negative. For this reason, the analyzer can easily understand the influences that multiple factors have on multiple subjects.

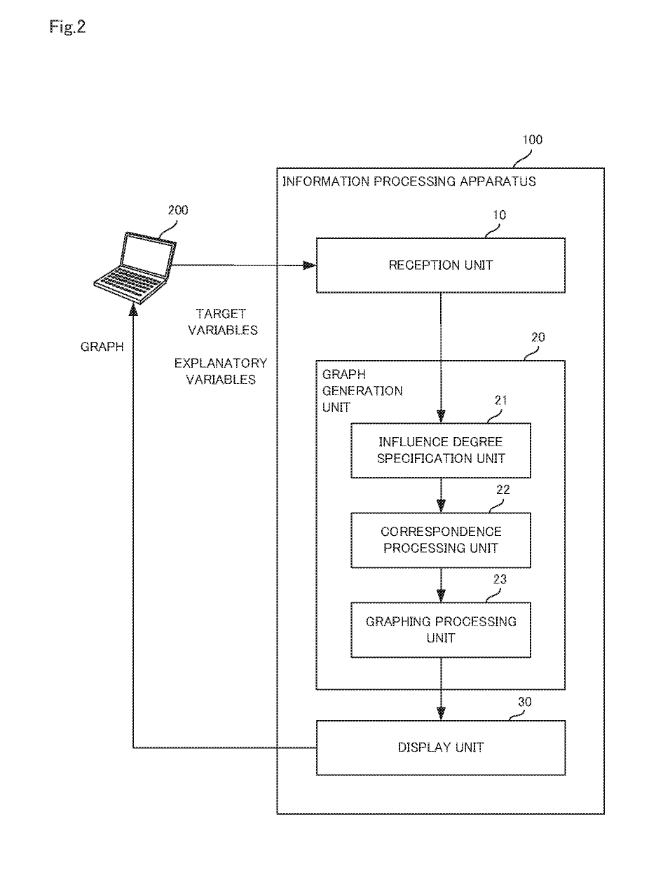

Next, a configuration of the information processing apparatus of the present embodiment will be further described in detail. FIG. 2 is a block diagram showing a specific configuration of an information processing apparatus according to an embodiment of the present invention.

First, the information processing apparatus 100 of the present embodiment can be used in a case of analyzing factors on the sales of specific products in retail, for example. Also, the information processing apparatus 100 is connected to a terminal apparatus 200 of the analyzer.

Also, in the present embodiment, the reception unit 10 receives input of multiple target variables and explanatory variables relating to the target variables from the terminal apparatus 200 of the analyzer. Examples of target variables include “sales of specific products (product A, product B, and the like)”. Also, examples of explanatory variables relating to the target variables include explanatory variables that influence sales, such as temperature, brightness of lighting, humidity, and the like.

Furthermore, the reception unit 10 may receive information indicating relationships between target variables and target variables variables instead of data indicating the target variables and the explanatory variables. Specifically, the reception unit 10 can receive the multiple regression equations (estimation equations) shown in Equations 1 and 2 below. The multiple regression equations are equations that include the target variables and the explanatory variables and specify the degrees of influence.

y1=a1×x1+a2×x2+ . . . Equation 1

y2=b1×x1+b2×x2+ . . . Equation 2

Also, if the target variables are the above-described sales of specific products, y1 is “sales of product A”, y2 is “sales of product B”, x1 is “room temperature of store”, and x2 is “room humidity of store”. Also, a1, a2, b1, and b2 are coefficients and are set in advance using the technique disclosed in the above-described Non-Patent Document 1.

Also, in the present embodiment, the graph generation unit 20 includes an influence degree specification unit 21, a correspondence processing unit 22, and a graphing processing unit 23. Among these, the influence degree specification unit 21 specifies the degrees of influence that the explanatory variables have on the target variables, with the degrees of influence divided into positive and negative. The correspondence processing unit 22 executes correspondence analysis on the degrees of positive influence and the degrees of negative influence.

Note that in the present embodiment, the correspondence analysis can be performed using a known method disclosed in the cited documents below.
(Reference) Nenadic, Oleg, and Michael Greenacre. “Correspondence analysis in R, with two- and three-dimensional graphics: The ca package.” (2007).

The graphing processing unit 23 generates a graph by arranging the explanatory variables and target variables in a two-dimensional coordinate system based on the result of executing the correspondence analysis. At this time, the graphing processing unit 23 can generate the graph by arranging first objects indicating the explanatory variables and second objects indicating the target variables on the two-dimensional coordinate system. Furthermore, the graphing processing unit 23 generates the graph such that the distance between the target variables is smaller the more similar their degrees of being influenced by a variable are.

Specifically, the influence degree specification unit 21 divides the variable (e.g., x1) into a case of having a positive coefficient (x1′) and a case of having a negative coefficient (x1″) in the received multiple regression equations (Equations 1 and 2).

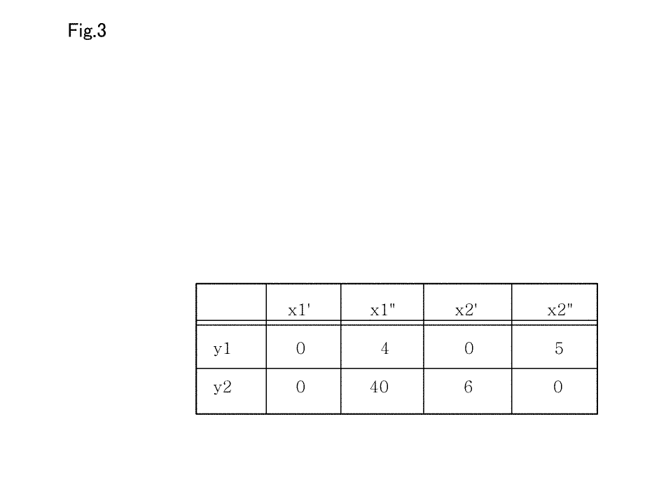

For example, if the received multiple regression equations are Equations 3 and 4 below (a1=−4, a2=−5, b1=−40, b2=−6), the influence degree specification unit 21 rewrites Equations 3 and 4 below to be Equations 5 and 6 below. As a result, the table shown in FIG. 3 is generated. FIG. 3 is a block diagram showing an example of results of processing for specifying a degree of influence according to an embodiment of the present invention.

y1=−4×x1−5×x2+ . . . Equation 3

y2=−40×x1+6×x2+ . . . Equation 4

y1=0×x1′−4×x1″+0×x2′+5×x2″ Equation 5

y2=0×x1′−40×x1″+6×x2′+0×x2″ Equation 6

Also, the correspondence processing unit 22 executes correspondence processing on the degrees of positive influence and the degrees of negative influence specified by the influence degree specification unit 21, or in other words, on the table shown in FIG. 3. Also, in the case of the example shown in FIG. 3, the correspondence processing unit 22 calculates the positions (coordinates) of y1, y2, x1′, x1“, x2′, and x2” in the two-dimensional coordinate system.

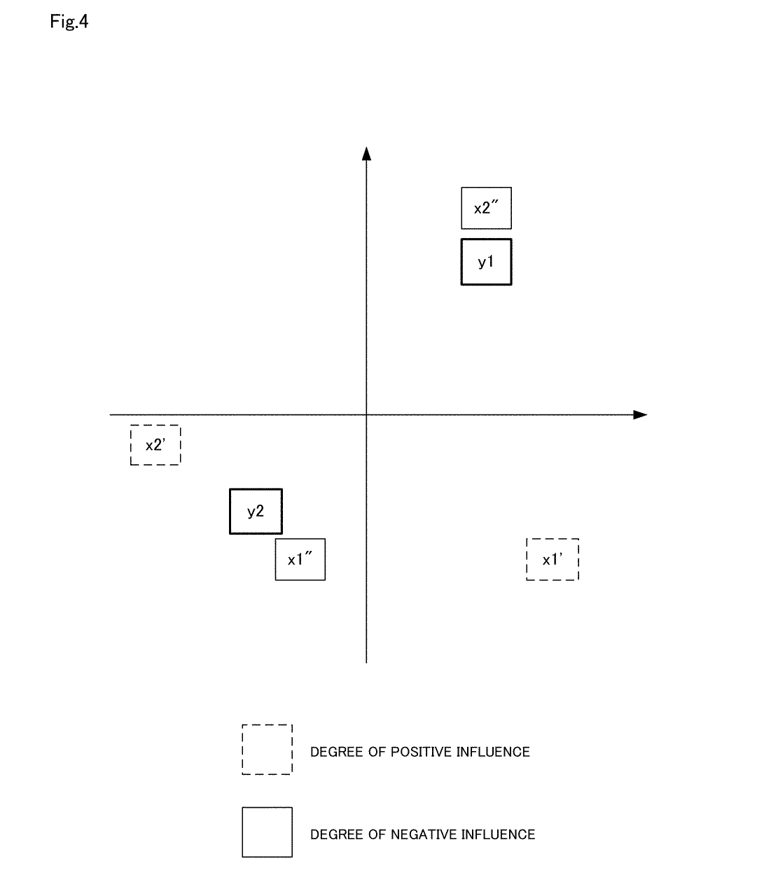

As shown in FIG. 4, the graphing processing unit 23 generates a graph by arranging corresponding objects at the positions calculated by the correspondence processing unit 22 in the two-dimensional coordinate system, as shown in FIG. 4. FIG. 4 is a diagram showing an example of a graph generated in an embodiment of the present invention.

Also, in the present embodiment, the information processing apparatus 100 includes a display unit 30. The display unit 30 creates image data of the graph generated by the graphing processing unit 23 and transmits the created image data to the terminal apparatus 200. Accordingly, the graph shown in FIG. 4 is displayed on the screen of the terminal apparatus 200.

In the example shown in FIG. 4, as described above, if y1 is “sales of product A”, y2 is “sales of product B”, x1 is “room temperature of store”, and x2 is “room humidity of store”, the analyzer can understand the following by looking at the graph. One is that “x1” (room temperature of store) has a strong negative influence on y2 (sales of product B) and has a weak negative influence on y1 (sales of product A)”. Also, one is that “x2′ (humidity of store) has a weak positive influence on y2 (sales of product B)”. Furthermore, one is that “x2” (humidity of store) has a weak negative influence on y1 (sales of product A)”.

Also, in the present embodiment, the graphing processing unit 23 can arrange circular objects as the objects indicating the target variables (y1, y2) in the two-dimensional coordinate system of the graph. In this case, the graphing processing unit 23 can also express the volumes of the target variables (net sales of the products) by the sizes of the circular objects. Furthermore, the graphing processing unit 23 can express the contents of the data relating to the target variables (e.g., the percentage of product A with respect to all products, and the like) by providing fan-shaped regions in the circular objects.

### Operations of Apparatus

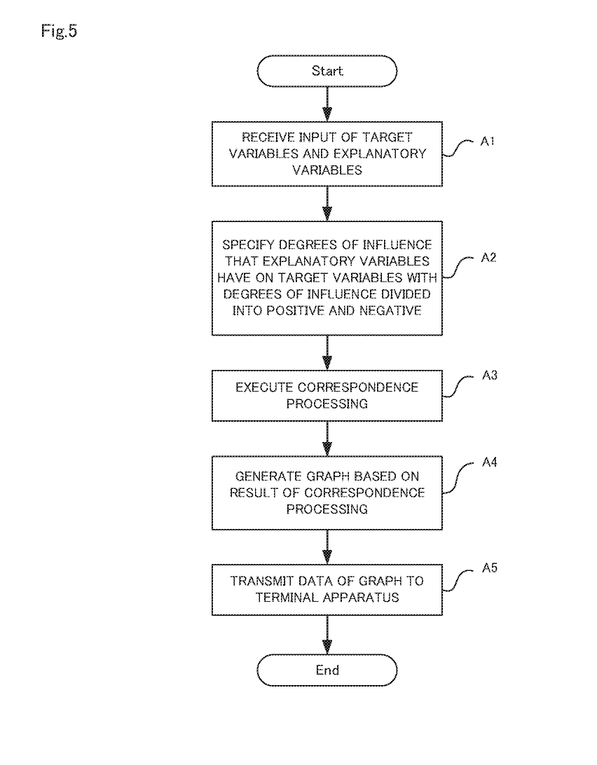

Next, operations of the information processing apparatus 100 according to an embodiment of the present invention will be described with reference to FIG. 5. FIG. 5 is a flow diagram showing an operation of an information processing apparatus according to an embodiment of the present invention. In the following description, FIG. 1 will be referenced as needed. Also, in the present embodiment, an information processing method is carried out by causing the information processing apparatus 100 to operate. Accordingly, the description of the information processing method according to the present embodiment will be substituted with the following description of operations of the information measurement apparatus.

As shown in FIG. 5, first, the reception unit 10 receives input of target variables and variables relating to the from the analyzer's terminal apparatus 200 (step A1). Specifically, in step A1, the terminal apparatus 200 outputs the target variables and explanatory variables using multiple regression equations (see Equations 1 and 2), and therefore the reception unit 10 receives input of the multiple regression equations.

Next, the influence degree specification unit 21 specifies the degrees of influence that the explanatory variables have on the target variables with the degrees of influence divided into positive and negative (step A2). Specifically, in step A2, the influence degree specification unit 21 divides each variable into a variable having a positive coefficient and a variable having a negative coefficient in the received multiple regression equations and performs re-writing of the multiple regression equations.

Next, the correspondence processing unit 22 executes correspondence analysis on the degrees of positive influence and the degrees of negative influence (step A3). The positions in the two-dimensional coordinate system of the target variables and the explanatory variables are specified by executing step A3.

Next, the graphing processing unit 23 generates a graph by arranging the corresponding objects at the positions specified through the correspondence analysis in step A3 (step A4). Thereafter, the display unit 30 creates image data of the graph created in step A4 and transmits the created image data to the terminal apparatus 200 (step A5). Accordingly, the graph shown in FIG. 4 is displayed on the screen of the terminal apparatus 200.

### Effects of the Embodiment

As described above, according to the present embodiment, the analyzer can understand specific products and factors relating to the sales thereof, for example, by merely viewing the generated graph. In particular, in the present embodiment, the degrees of influence that explanatory variables have on the target variables are divided into positive and negative and expressed on a graph, and furthermore, the distance between the target variables is smaller the more similar the degrees to which they are influenced by the explanatory variables are. Accordingly, through visual confirmation, the analyzer can understand whether the temperature of the store has an influence on improving the sales of the specific products or has an influence on reducing the sales, and furthermore, which products are in a close relationship, for example. For this reason, it is possible to easily consider a measure for achieving an improvement in the sales of specific products while giving consideration to the importance of the specific products, and costs and the like needed for the store, and the like.

### Specific Example

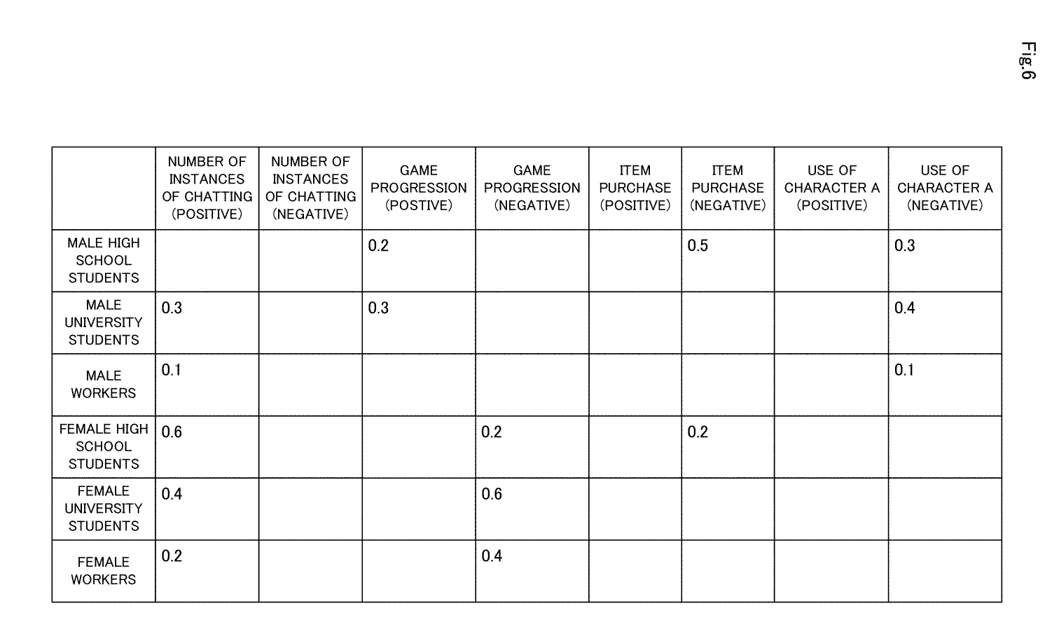

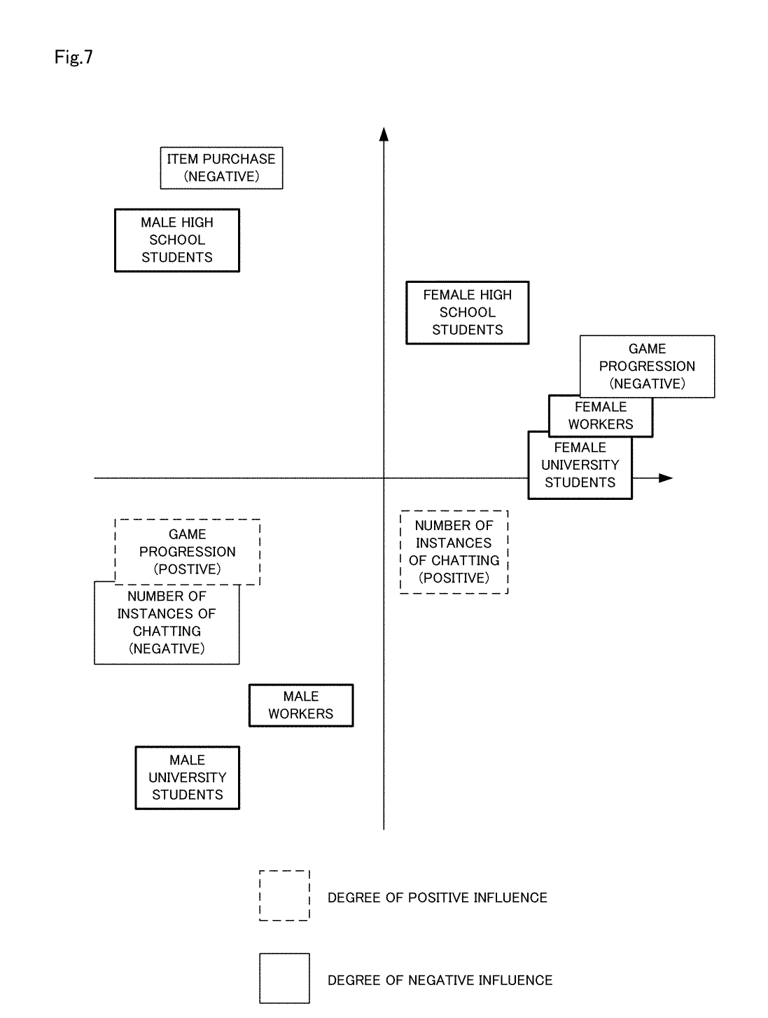

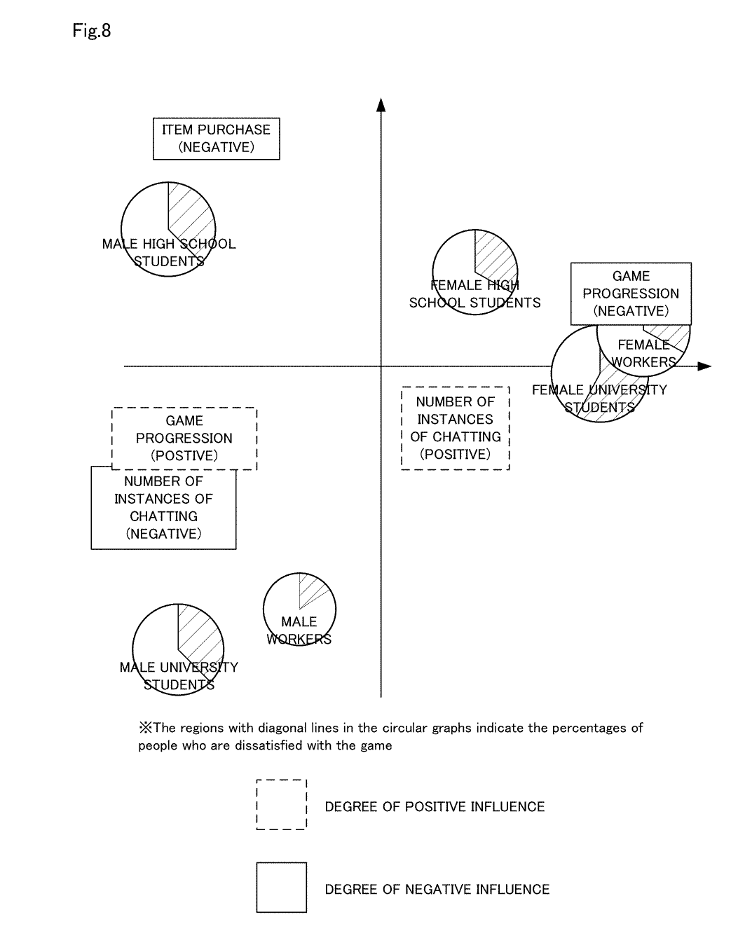

Next, a specific example of the present embodiment will be described with reference to FIGS. 6 to 8. FIG. 6 is a diagram showing results of processing for specifying degrees of influence according to a specific example of an embodiment of the present invention. FIG. 7 is a diagram showing an example of a graph generated in a specific example of an embodiment of the present invention. FIG. 8 is a diagram showing another example of a graph generated in a specific example of an embodiment of the present invention.

First, in the present example, the analyzer sets six segments, namely male high school students, male university students, male workers, female high school students, female university students, and female workers as the target variables (segments). Furthermore, for each segment, the analyzer makes a prediction regarding dissatisfaction with an online game (y=1: dissatisfied, y=0: satisfied).

Also, at this time, it is assumed that the number of instances of chatting, game progress, item purchase, and use of character A are extracted as factors that influence the level of satisfaction with the online game. Note that regarding the use of character A, character A is a character that is operated by the player and the quality of character A significantly influences the level of satisfaction of the player.

Next, the analyzer creates multiple regression equations (y=log it(coefficient×characteristic amount) using the extracted factors as explanatory variables for each segment, and outputs the created multiple regression equations to the information processing apparatus 100 via the terminal apparatus 200. Accordingly, with the information processing apparatus 100, the input of the multiple regression equations is received by the reception unit 10 and the processing performed by the influence degree specification unit 21 is performed. As a result, the table shown in FIG. 6 is generated.

Next, the correspondence processing unit 22 uses the table shown in FIG. 6 to create rows and columns and executes the correspondence analysis. As a result, as will be described below, the positions (coordinates) of the segments and the explanatory variables on the two-dimensional coordinate system are specified.

Number of instances of chatting (positive): (0.400474946871, −0.166813198132)

Game progression (positive): (−1.03563976512, −0.438361452553)
Game progression (negative): (1.03007728328, 0.103605589165)
Item purchase (negative): (−0.832791552746, 1.06921016533)
Character A (negative): (−0.970098356813, −0.483364974301)
Male high school students: (−1.10224041402, 0.61935846618)
Male university students: (−0.697328400404, −0.769057865908)
Male workers: (−0.34326156105, −0.666880223891)
Female high school students: (0.337151574693, 0.275859377135)
Female university students: (0.937948192664, −0.00935822885785)
Female workers: (0.988535598791, 0.0276238270489)

Next, the graphing processing unit 23 arranges the corresponding objects at the specified positions of the segments and the variables. As a result, the graph shown in FIG. 7 is created, and the display unit 30 displays the created graph on the screen of the terminal apparatus 200.

When the graph shown in FIG. 7 is displayed, the analyzer first determines that the factors for the satisfaction levels of female workers and the factors for the satisfaction levels of female university students are similar, due to the fact that the distance between female workers and female university students is small. Furthermore, by viewing the graph, the analyzer determines that the factor for the satisfaction levels of the female workers and the female university students is game progression, and that the game progression has a weak negative effect on the satisfaction levels of the female workers and the female university students. For this reason, the analyzer thinks that female workers and female university students both tend to quickly lose interest upon playing the game a little, for example. Accordingly, if it is assumed that the female workers and female university students are important customers, the analyzer suggests incorporating a means by which the user will not lose interest even when the game progresses (addition of a new story, etc.) to the developer, for example.

Also, as shown in FIG. 8, the graphing processing unit 23 can arrange circular objects in the two-dimensional coordinate system of the graph as objects indicating the segments. Also, in the example in FIG. 8, the graphing processing unit 23 expresses the number of people constituting the segments by the sizes of the circular objections. Furthermore, the graphing processing unit 23 can express the percentage of people that are dissatisfied with the game in each segment by providing fan-shaped regions (the regions indicated by diagonal lines in FIG. 8) in the circular objects.

### Program

The program according to an embodiment of the present invention need only be a program that causes a computer to execute steps A1 to A5 shown in FIG. 5. The information processing apparatus and the information processing method according to the present embodiment can be realized by installing the program on a computer and executing it. In this case, the CPU (Central Processing Unit) of the computer functions as the reception unit 10, the graph generation unit 20, and the display unit 30 and performs the processing.

Also, the program according to the present embodiment may be executed by a computer system constructed by multiple computers. In this case, for example, the computers may each function as one of the reception unit 10, the graph generation unit 20, and the display unit 30.

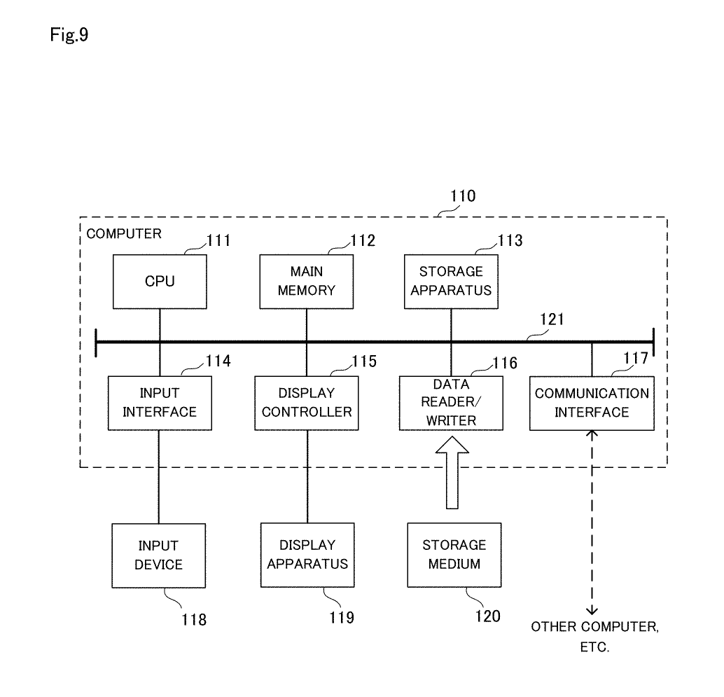

Here, a computer that realizes the information processing apparatus 100 by executing the program according to the present embodiment will be described with reference to FIG. 9. FIG. 9 is a block diagram showing an example of a computer that realizes an information processing apparatus according to an embodiment of the present invention.

As shown in FIG. 9, the computer 110 includes a CPU 111, a main memory 112, a storage apparatus 113, an input interface 114, a display controller 115, a data reader/writer 116, and a communication interface 117. These units are connected via a bus 121 so as to be able to perform data communication with each other.

The CPU 111 carries out various calculations by expanding the program (code) according to the present embodiment, which is stored in the storage apparatus 113, to the main memory 112, and executing it in a predetermined sequence. The main memory 112 is typically a volatile storage apparatus such as a DRAM (Dynamic Random Access Memory). Also, the program according to the present embodiment is provided in a state of being stored in a computer-readable storage medium 120. Note that the program according to the present embodiment may be distributed over the Internet, which is connected to via the communication interface 117.

Also, specific examples of the storage apparatus 113 include semiconductor storage apparatuses such as flash memories, in addition to hard disk drives. The input interface 114 mediates data transmission between the CPU 111 and an input device 118 such as a keyboard or a mouse. The display controller 115 is connected to the display apparatus 119 and controls display on the display apparatus 119.

The data reader/writer 116 mediates data transmission between the CPU 111 and the storage medium 120 and executes reading out of programs from the storage medium 120 and writing processing results of the computer 110 in the storage medium 120. The communication interface 117 mediates data transmission between the CPU 111 and another computer.

Also, specific examples of the storage medium 120 include general-purpose semiconductor storage devices such as CF (Compact Flash (registered trademark)) and SD (Secure Digital), magnetic storage mediums such as flexible disks, and optical storage mediums such as a CD-ROM (Compact Disk Read Only Memory).

Note that the information processing apparatus 100 according to the present embodiment can be realized by using hardware corresponding to the units instead of using a computer on which a program is installed. Furthermore, portions of the information processing apparatus 100 may be realized using a program and the remaining portions may be realized by hardware.

Although the present invention was described above with reference to an embodiment, the present invention is not limited to the above-described embodiment. Configurations and details of the present invention can be subjected to various modifications that a person skilled in the art can understand within the scope of the present invention.

This application claims priority to U.S. Provisional Application 62/212,084, filed on Aug. 31, 2015, the disclosure of which is incorporated in its entirety herein by reference.

### INDUSTRIAL APPLICABILITY

As described above, with the present invention, it is possible for an analyzer to easily understand the influence that multiple factors have on multiple subjects. The present invention is useful in various fields, such as retail, marketing, and consulting.

### DESCRIPTIONS OF REFERENCE NUMERALS

10 Reception unit
20 Graph generation unit
21 Influence degree specification unit
22 Correspondence processing unit
23 Graphing processing unit
30 Display unit
100 Information processing apparatus
110 Computer
111 CPU
112 Main memory
113 Storage apparatus
114 Input interface
115 Display controller
116 Data reader/writer
117 Communication interface
118 Input device
119 Display apparatus
120 Storage medium
121 Bus
200 Terminal apparatus

1. An information processing apparatus, comprising:
a reception unit configured to receive target variables and explanatory variables relating to the analysis subjects; and
a graph generation unit configured to specify degrees of influence that the variables have on the target variables with the degrees of influence divided into positive and negative and generate a graph showing the specified degrees of positive influence and the specified degrees of negative influence as distances between the explanatory variables and the target variables.

2. The information processing apparatus according to claim 1, wherein
the reception unit receives multiple regression equations that include the target variables and the explanatory variables and are for specifying the degrees of influence.

3. The information processing apparatus according to claim 1, wherein
the graph generation unit generates the graph by executing correspondence analysis on the specified degrees of positive influence and the specified degrees of negative influence and arranging the explanatory variables and the target variables in a two-dimensional coordinate system based on the execution result.

4. The information processing apparatus according to claim 1, wherein
the graph generation unit generates the graph such that if there are a plurality of target variables, the distance between the target variables is smaller the more similar the degrees of influence that the explanatory variables have on the target variables are.

5. The information processing apparatus according to claim 4, wherein
the graph generation unit generates the graph by arranging first objects indicating the explanatory variables and second objects indicating the target variables in the two-dimensional coordinate system.

6. The information processing apparatus according to claim 5, wherein
the graph generation unit arranges circular objects in the two-dimensional coordinate system as the second objects, expresses volumes of the target variables by the sizes of the circular objects, and expresses contents of data relating to the target variables by providing fan-shaped regions in the objects.

7. An information processing method, comprising:
(a) a step of receiving target variables and explanatory variables relating to the target variables; and
(b) a step of specifying degrees of influence that the explanatory variables have on the target variables with the degrees of influence divided into positive and negative, and generating a graph showing the specified degrees of positive influence and the specified degrees of negative influence as distances between the explanatory variables and the target variables.

8. The information processing method according to claim 7, wherein
in the (a) step, multiple regression equations that include the target variables and the explanatory variables and are for specifying the degrees of influence are received.

9. The information processing method according to claim 7, wherein
in the (b) step, correspondence analysis is executed on the specified degrees of positive influence and the degrees of negative influence, and the graph is generated by arranging the explanatory variables and the target variables in a two-dimensional coordinate system based on the execution result.

10. The information processing method according to claim 7, wherein
in the (b) step, the graph is generated such that if there are a plurality of target variables, the distance between target variables is smaller the more similar the degrees of influence that the explanatory variables have on the target variables are.

11. The information processing method according to claim 10, wherein
in the (b) step, the graph is generated by arranging first objects indicating the explanatory variables and second objects indicating the target variables in the two-dimensional coordinate system.

12. The information processing method according to claim 11, wherein
in the (b) step, circular objects are arranged in the two-dimensional coordinate system as the second objects, volumes of the target variables are expressed by the sizes of the circular objects, and furthermore, contents of data relating to the target variables are expressed by providing fan-shaped regions in the objects.

13. A non-transitory computer-readable storage medium storing a program that includes commands for causing a computer to execute:
(a) a step of receiving target variables and explanatory variables relating to the target variables; and
(b) a step of specifying degrees of influence that the explanatory variables have on the target variables with the degrees of influence divided into positive and negative, and generating a graph showing the specified degrees of positive influence and the specified degrees of negative influence as distances between the explanatory variables and the target variables.

14. The non-transitory computer-readable storage medium according to claim 13, wherein
in the (a) step, multiple regression equations that include the target variables and the explanatory variables and are for specifying the degrees of influence are received.

15. The non-transitory computer-readable storage medium according to claim 13, wherein
in the (b) step, correspondence analysis is executed on the specified degrees of positive influence and the degrees of negative influence, and the graph is generated by arranging the explanatory variables and the target variables in a two-dimensional coordinate system based on the execution result.

16. The non-transitory computer-readable storage medium according to claim 13, wherein
in the (b) step, the graph is generated such that if there are a plurality of target variables, the distance between target variables is smaller the more similar the degrees of influence that the explanatory variables have on the target variables are.

17. The non-transitory computer-readable storage medium according to claim 16, wherein
in the (b) step, the graph is generated by arranging first objects indicating the explanatory variables and second objects indicating the target variables in the two-dimensional coordinate system.

18. The non-transitory computer-readable storage medium according to claim 17, wherein
in the (b) step, circular objects are arranged in the two-dimensional coordinate system as the second objects, volumes of the target variables are expressed by the sizes of the circular objects, and furthermore, contents of data relating to the target variables are expressed by providing fan-shaped regions in the objects.
